(19) United States
(12) Patent Application Publication
(10) Pub. No.: US 2022/0043799 A1
(43) Pub. Date: Feb. 10, 2022

(54) METHOD, DEVICE, AND COMPUTER PROGRAM PRODUCT FOR METADATA COMPARISON

(71) Applicant: EMC IP Holding Company LLC, Hopkinton, MA (US)

(72) Inventors: Lanjun Liao, Chengdu (CN); Qin LIU, Chengdu (CN)

(21) Appl. No.: 17/063,094

(22) Filed: Oct. 5, 2020

(30) Foreign Application Priority Data
Aug. 7, 2020 (CN) 202010791575.5

(51) Int. Cl. G06F 16/23; G06F 16/22

(52) U.S. Cl. CPC G06F 16/2365; G06F 16/2246

(57) ABSTRACT

A method, a device, and a computer program product for metadata comparison are provided in embodiments of the present disclosure. A method for metadata comparison includes setting a source pointer to point to a first node in a first metadata tree corresponding to source data; if it is determined that the first node has at least one child node in the first metadata tree, reading a first child node set of the first node from a first storage system; if it is determined that a target pointer points to a second node in a second metadata tree corresponding to target data, determining a second child node set of the second node, wherein the target data is a replicated version of the source data, and the second node is the same as the first node; and determining a differential metadata tree of the first metadata tree with respect to the second metadata tree at least in part by determining a difference between the first child node set and the second child node set.

### TECHNICAL FIELD

Embodiments of the present disclosure relate to the field of data storage, and more particularly, to a method, a device, and a computer program product for metadata comparison.

### BACKGROUND

In the field of storage, a replicated version may be generated for stored data in consideration of data security such as disaster tolerance and backup. Source data and its replicated version may be stored in different storage systems and controlled by different servers (for example, a source server and a target server). In this way, if the source data is in a disaster, data recovery may be performed using the replicated version, thereby avoiding data loss. In a data maintenance process, a data replication process may need to be executed periodically or according to a trigger, for synchronizing the source data with the replicated version, so that the replicated version can reflect an update of the source data. Generally, the source data may be of a very large size, and therefore, an updated data part of the source data may be replicated to the replicated version in the data replication process. A difference between the source data and its replicated version can be quickly positioned by comparing metadata corresponding to the source data with metadata corresponding to the replicated version. A different part in the metadata may indicate the difference between the corresponding source data and the replicated version. Therefore, improvement of the efficiency and resource overhead of metadata comparison may affect the efficiency and resource overhead of the entire data replication process.

### SUMMARY OF THE INVENTION

A solution for metadata comparison in data replication is provided in the embodiments of the present disclosure.

In a first aspect of the present disclosure, a method for metadata comparison is provided. The method includes setting a source pointer to point to a first node in a first metadata tree corresponding to source data; if it is determined that the first node has at least one child node in the first metadata tree, reading a first child node set of the first node from a first storage system; if it is determined that a target pointer points to a second node in a second metadata tree corresponding to target data, determining a second child node set of the second node, wherein the target data is a replicated version of the source data, and the second node is the same as the first node; and determining a differential metadata tree of the first metadata tree with respect to the second metadata tree at least in part by determining a difference between the first child node set and the second child node set.

In a second aspect of the present disclosure, an electronic device is provided. The electronic device includes a processor; and a memory coupled to the processor and storing instructions that need to be executed. The instructions, when executed by the processor, cause the electronic device to perform actions. The actions include: setting a source pointer to point to a first node in a first metadata tree corresponding to source data; if it is determined that the first node has at least one child node in the first metadata tree, reading a first child node set of the first node from a first storage system; if it is determined that a target pointer points to a second node in a second metadata tree corresponding to target data, determining a second child node set of the second node, wherein the target data is a replicated version of the source data, and the second node is the same as the first node; and determining a differential metadata tree of the first metadata tree with respect to the second metadata tree at least in part by determining a difference between the first child node set and the second child node set.

In a third aspect of the present disclosure, a computer program product is provided. The computer program product is tangibly stored in a computer-readable medium and including computer-executable instructions, wherein when executed, the computer-executable instructions cause a processor to perform actions. The actions include: setting a source pointer to point to a first node in a first metadata tree corresponding to source data; if it is determined that the first node has at least one child node in the first metadata tree, reading a first child node set of the first node from a first storage system; if it is determined that a target pointer points to a second node in a second metadata tree corresponding to target data, determining a second child node set of the second node, wherein the target data is a replicated version of the source data, and the second node is the same as the first node; and determining a differential metadata tree of the first metadata tree with respect to the second metadata tree at least in part by determining a difference between the first child node set and the second child node set.

The Summary part is provided to introduce the selection of concepts in a simplified form, which will be further described in the Detailed Description below. The Summary part is neither intended to identify key features or main features of the present disclosure, nor intended to limit the scope of the present disclosure.

### BRIEF DESCRIPTION OF THE DRAWINGS

By description of example embodiments of the present disclosure in more detail with reference to the accompanying drawings, the above and other objectives, features, and advantages of the present disclosure will become more apparent. In the example embodiments of the present disclosure, the same reference numerals generally represent the same components.

FIG. 1 is a block diagram of an environment in which an embodiment of the present disclosure can be implemented;

FIG. 2 illustrates an example of a metadata tree on the side of a target server;

FIG. 3 is a flowchart of a process of metadata comparison according to some embodiments of the present disclosure;

FIG. 4A to FIG. 4E illustrate some examples of a comparison process of a metadata tree according to some embodiments of the present disclosure;

FIG. 5 illustrates an example of states of nodes of a metadata tree during metadata comparison according to some embodiments of the present disclosure; and

FIG. 6 is a block diagram of an example device that can be configured to implement an embodiment of the present disclosure.

### DETAILED DESCRIPTION

The principles of the present disclosure will be described below with reference to some example embodiments shown in the accompanying drawings. Although preferred embodiments of the present disclosure are shown in the accompanying drawings, it should be understood that these embodiments are described merely to enable those skilled in the art to better understand and then implement the present disclosure, and do not limit the scope of the present disclosure in any way.

The term “including” and variants thereof used herein indicate open-ended inclusion, that is, “including, but not limited to.” Unless specifically stated, the term “or” indicates “and/or.” The term “based on” indicates “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects. Other explicit and implicit definitions may also be included below.

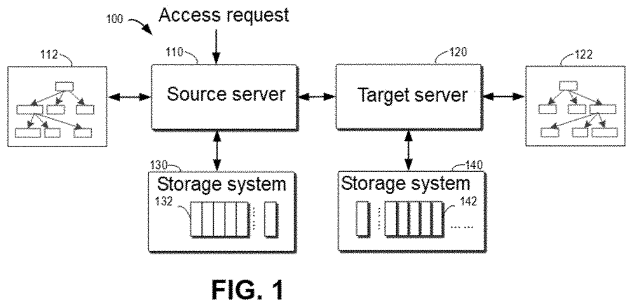

FIG. 1 is a block diagram of environment 100 in which an embodiment of the present disclosure can be implemented. It should be understood that the architecture and function of environment 100 are described for example purposes only, and do not imply any limitation to the scope of the present disclosure. The embodiments of the present disclosure may also be applied to environments involving data storage (also referred to as data protection) systems with different structures and/or functions.

As shown in FIG. 1, in environment 100, source server (sometimes also referred to as source controller) 110 is configured to control and manage storage system 130. Storage system 130 stores data 132 (referred to as source data). Source server 110 may, with an access request from a user or a client, store the data as metadata 132 or update metadata 132, such as perform modification, deletion, addition, or replacement on metadata 132. In some embodiments, source data 132 may be partitioned into data blocks for storage, which depends on a storage technology adopted by storage system 130.

In environment 100, target server (sometimes also referred to as target controller) 120 is configured to control and manage storage system 140. Storage system 140 stores data 142. Data 142 may include a replicated version of source data 132, which is sometimes referred to as target data 142 for ease of discussion. By creating a replicated version of the data, disaster tolerance of the data can be improved, and data loss when a disaster occurs in storage system 132 can be avoided. Data replication is similar to server- or system-level backup.

Storage systems 130 and 140 may be constructed based on one or more storage disks or storage nodes. The storage disks configured to construct the storage systems may be various types of storage disks, which include, but are not limited to, solid-state drives (SSDs), magnetic disks, optical discs, and the like. Storage systems 130 and 140 may be implemented using the same or different storage technologies.

In order to better manage stored source data 132, source server 110 further maintains metadata corresponding to source data 132. Metadata may be organized into a tree structure, which is referred to as metadata tree 112 (for ease of discussion, it is referred to as first metadata tree 112). First metadata tree 112 includes a plurality of nodes, which are organized into a certain tree-like hierarchical structure. A path formed from a root node to an end node (that is, a node without subsequent child nodes) in first metadata tree 112 may indicate an access path to at least a part of source data 132, such as an access path to one or more data blocks.

Similarly, target server 120 also maintains metadata corresponding to the data stored in storage system 140. Metadata may be organized into a tree structure, which is referred to as metadata tree 122 (for ease of discussion, it is referred to as second metadata tree 122). Second metadata tree 122 includes a plurality of nodes, which are organized in a certain hierarchical structure. A path formed from a root node to an end node (that is, the node without child nodes) in second metadata tree 122 may indicate at least a part of the data stored in storage system 140, for example, one or more data blocks.

In some embodiments, in addition to source data 132, storage system 140 may further store replicated versions of data in one or more other storage systems. Therefore, second metadata tree 122 maintained by target server 120 may correspond to more data than target data 142. Other data may correspond to replicated versions of source data in other storage systems.

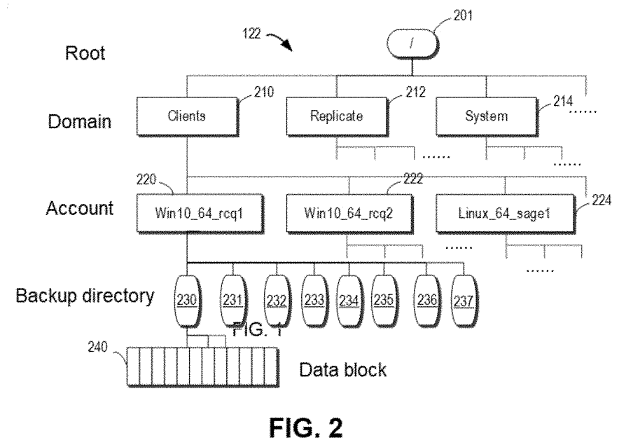

FIG. 2 illustrates an example of second metadata tree 122 on the side of target server 120. Under root node 201, the metadata is partitioned into a plurality of domains. Nodes 210, 212, 214 each correspond to a different domain, which are denoted as “clients,” “Replicate,” “System,” and so on, wherein “clients” node 210 corresponds to the replicated version of source data 132 stored in source server 110, “Replicate” node 212 corresponds to the replicated version of the source data stored in another server 110, and “System” node 214 indicates system data.

According to different accounts that generate source data 132, “clients” node 210 further has a plurality of child nodes 220, 222, 224, and the like, and different nodes correspond to replicated parts of the data generated under the different accounts. Each node 220, 222, 224, or the like may also continue to create a backup directory for each backup according to a backup situation of the corresponding account. For example, node 220 includes child nodes 230 to 237, which correspond to different backups respectively. Child nodes 230 to 237 are end nodes in second structure tree 122, which point to a group of data blocks in stored target data 142. For example, child node 230 points to a group of data blocks 240. Data blocks 240 include data actually stored in storage system 140. Depending on a data backup strategy, backup directories indicated by different child nodes 230 to 237 may point to one or more identical data blocks, if contents of these data blocks do not change when two backup directories are created. Starting from root node 201, a corresponding data block can be found through searching layer by layer according to indexes corresponding to the data blocks.

It should be understood that FIG. 2 illustrates only one example of the metadata tree. For clarity, FIG. 2 does not illustrate further child nodes of some nodes. For example, “Replicate” node 212 and “System” node 214 may also have child nodes. Although not shown in the drawings, first metadata tree 112 may also have a similar hierarchical tree structure, which indicates the metadata corresponding to source data 132. In some embodiments, storage system 140 may also be configured to store only a replicated version of source data 132 (that is, target data 142). In this case, second metadata tree 122 may completely correspond to target data 142 and does not include metadata for other data.

Although shown outside the storage system in FIG. 1, first metadata tree 112 and second metadata tree 122 may also be stored in storage systems 130 and 140, respectively. The metadata may be stored in the same manner as those for actual source data and target data, depending on storage technologies adopted by storage systems 130 and 140.

Since source data 132 may change, source server 110 may initiate a data replication process periodically or according to an event trigger to keep target data 142 consistent with source data 132. In order to reduce the consumption of data reading and data transmission, it is desirable to replicate an updated part (that is, a difference data part) of source data 132 to target data 142 through incremental replication. First metadata tree 112 corresponding to source data 132 may be compared with second metadata tree 122 corresponding to the target data, so as to better position the difference data part.

According to conventional solutions, the comparison of metadata trees may lead to relatively large storage overhead and many network I/O requests, resulting in problems such as relatively low efficiency and large overhead. For example, in a conventional solution, if data replication is to be initiated, the source server completely acquires and stores the first metadata tree corresponding to the source data and the second metadata tree corresponding to the target data, and then determines, by tree traversal, a part of the second metadata tree that is different from the first metadata tree. In some storage systems, the metadata, like actual data, is partitioned into corresponding data blocks and stored in different storage nodes. For example, in a content addressable storage (CAS) system, the metadata may be evenly stored in each storage node of the storage system. Therefore, acquisition of all the contents of the first metadata tree and the second metadata tree may result in a large number of network I/O requests, and may lead to a large delay. In addition, with an increase in the amount of the source data and in the amount of the target data and a data organization structure, the amount of the first metadata tree and the amount of the second metadata tree are also very large, and acquisition and storage of the whole trees for comparison may also lead to high storage overhead.

In addition, the second metadata tree may include metadata parts corresponding to other replicated versions other than the replicated version of the current source data, for example, metadata parts corresponding to “Replicate” node 212 and “System” node 214 in FIG. 2 and their child nodes. Such metadata parts are useless for comparison with the first metadata tree.

It can be seen that the current method for metadata comparison consumes a lot of resources in terms of network resources and storage resources, and may introduce a large delay, which affects the efficiency of the data replication process.

According to an embodiment of the present disclosure, an improved solution for metadata comparison is proposed. According to the solution, through the introduction of a source pointer and a target pointer, when a first node in a first metadata tree corresponding to the source data is traversed, a child node of the first node is read, and it is also determined whether a second node in a second metadata tree that corresponds to the first node has a child node. If the second node does not have any child node, the child node of the first node is considered as not existing in the second metadata tree, and if the second node has a child node, the child node of the second node is read. A differential metadata tree of the first metadata tree with respect to the second metadata tree is determined by comparing a difference between the child node of the first node and the child node of the second node.

According to the embodiment of the present disclosure, the comparison is made by traversing from each node and its child nodes, without reading a complete metadata tree. The differential metadata tree is generated at least by comparing child nodes of current corresponding nodes in the first metadata tree and the second metadata tree. Depending on the comparison result of the child nodes and situations of the child nodes, other nodes can be continuously read to continue the comparison.

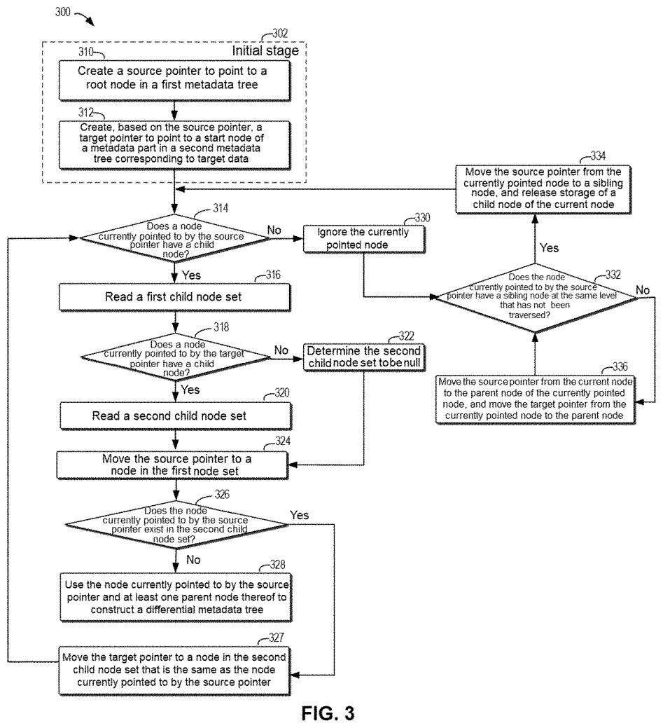

How to implement the comparison of the metadata trees will be described in detail hereinafter. FIG. 3 is a flowchart of process 300 for metadata comparison according to some embodiments of the present disclosure. Process 300 may be implemented by source server 110 in environment 100 of FIG. 1, because source server 110 may initiate a metadata comparison in a data replication process to determine which data is to be replicated from storage system 130 to storage system 140. In other embodiments, other devices may also perform comparison of metadata trees for other purposes, and the embodiments of the present disclosure are not limited in this respect.

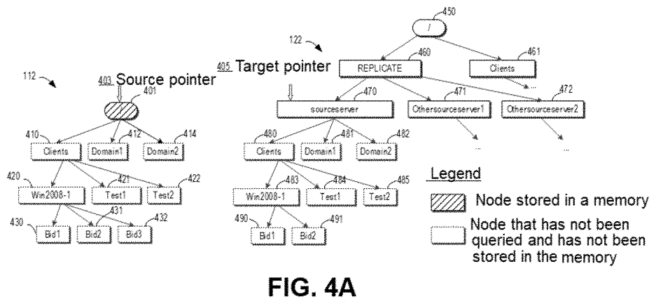

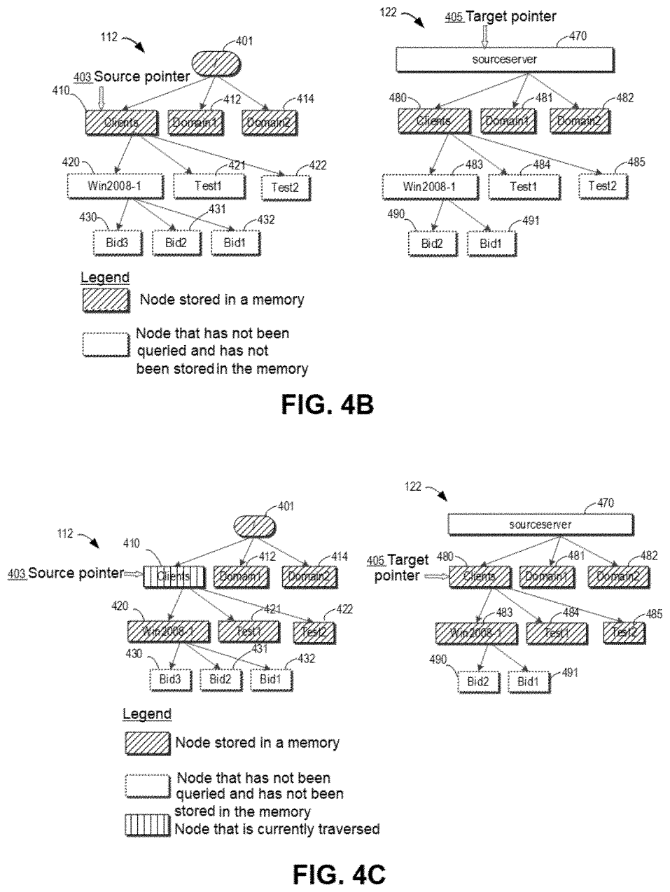

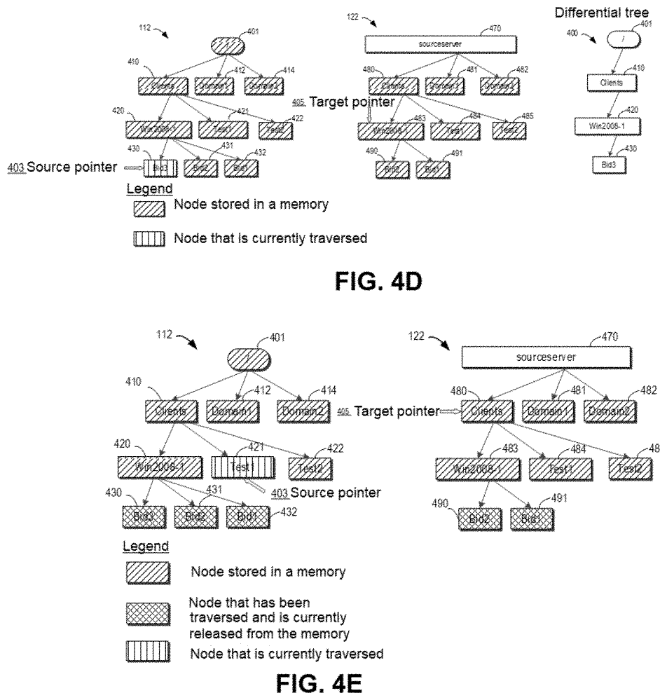

For ease of understanding, process 300 for metadata comparison may also be discussed with reference to the examples of FIG. 4A to FIG. 4E. It should be understood that the metadata trees shown in FIG. 4A to FIG. 4E are only examples and not any limitation to the scope of the present disclosure.

In the embodiment of the present disclosure, a source pointer is provided for first metadata tree 112 corresponding to source data 132, and a target pointer is provided for second metadata tree 122 corresponding to target data 142, which are configured to guide comparison of the metadata trees.

In an initial stage, as shown in FIG. 3, in block 310, source server 110 creates a source pointer to point to a root node of first metadata tree 112. As shown in FIG. 4A, source pointer 403 is created to point to root node 401 of first metadata tree 112. In some embodiments, root node 401 may be read by source server 110 from, for example, storage system 130 into a memory, such as a local memory of source server 110 or another directly accessible memory.

In block 312, source server 110 creates, based on source pointer 403, a target pointer to initially point to a start node of a metadata part in second metadata tree 122 corresponding to target data 142. If second metadata tree 122 includes only the metadata corresponding to target data 142, the start node is a root node in second metadata tree 122. If second metadata tree 122 further includes metadata corresponding to other data, the target pointer may point to a node under the root node of second metadata tree 122.

As shown in FIG. 4A, in second metadata tree 122, root node 450 includes a plurality of child nodes 460 and 461. Among the plurality of child nodes of node 460, node “sourceserver” 470 corresponds to a start node of target data 142. Specifically, since source pointer 403 points to root node 401, a path of source data 132 corresponding thereto is represented as “/*.” In storage system 140, a path “/REPLICATE/sourceserver/*” points to target data 142, which corresponds to the replicated version of source data 132. Thus, target pointer 405 may be initially created to point to node 470. In some embodiments, node 470 may be read by source server 110 from, for example, storage system 140 into a memory, such as a local memory of source server 110 or another directly accessible memory.

In an initial stage for setting the source pointer and the target pointer, neither the root node nor subsequent child nodes of the start node need to be read to the memory, as illustrated in the legend of FIG. 4A. After the nodes pointed to by source pointer 403 and target pointer 405 are determined, source server 110 determines metadata information to access the two pointers.

Specifically, in block 314, source server 110 determines whether a node currently pointed to by source pointer 403 has a child node. If the node currently pointed to by source pointer 403 has a child node, especially if such child node exists when source pointer 403 is created to point to root node 401 in the initial stage, in block 316, source server 110 reads one or more child nodes for the node currently pointed to by source pointer 403 as a first child node set.

In block 318, source server 110 determines whether a node currently pointed to by target pointer 405 has a child node. If the node currently pointed to by target pointer 405 has one or more child nodes, especially if such child node exists when target pointer 405 is created to point to start node 470 in the initial stage, in block 320, source server 110 reads one or more child nodes of the node currently pointed to by target pointer 405 as a second child node set. In some embodiments, the steps of block 318 and/or block 320 may be performed, in parallel or in reverse order, with the steps of block 314 and/or block 316.

As shown in FIG. 4B, in first metadata tree 112, child nodes 410, 412, and 414 of root node 401 currently pointed to by source pointer 403 are read into the memory to form the first child node set. In second metadata tree 122, child nodes 480, 481, and 482 of node 470 currently pointed to by target pointer 405 are read into the memory to form the second child node set.

If the node currently pointed to by target pointer 405 does not have one or more child nodes (which may occur when process 300 iterates to some nodes), in block 322, source server 110 may also determine the second child node set to be null.

It can be seen that, depending on the nodes currently pointed to by source pointer 403 and target pointer 405, source server 110 may read and store the child nodes of the current two nodes in their respective metadata trees without reading other subsequent nodes. Source server 110 may determine a differential metadata tree of first metadata tree 112 with respect to second metadata tree 122 at least in part by determining a difference between the currently determined first child node set and second child node set.

During the determination of the difference between the first child node set and the second child node set, since these nodes may have subsequent child nodes, how to continuously read and store the subsequent child nodes for comparison may also be determined by continuously moving source pointer 403 and target pointer 405.

Specifically, process 300 proceeds to block 324, and source server 110 moves source pointer 403 to a node in the first child node set. The child nodes may be sorted according to a certain rule. For example, the child nodes are sorted in alphanumeric order of the metadata corresponding to the child nodes, and so on. As will be described later, source pointer 403 will traverse various sibling nodes in the first child node set (that is, nodes at the same level in first metadata tree 112), and therefore, to which node each time source pointer 403 is to be moved can be determined faster by sorting. As shown in FIG. 4B, source pointer 403 is moved to node “Clients” 410.

In block 326, source server 110 further determines whether the node currently pointed to by source pointer 403 exists in the second child node set (that is, a child node of the node currently pointed to by target pointer 405), that is, judges whether a node the same as the node currently pointed to by source pointer 403 exists in second metadata tree 122.

In the example of FIG. 4B, source server 110 determines whether node 410 in first metadata tree 112 exists in the second child node set, including nodes 480, 481, and 482. Source server 110 may determine that node 480 is the same as node 410.

If it is determined that the node currently pointed to by source pointer 403 exists in the second child node set, that is, the same node is found in the second child node set, process 300 returns to block 327, in which source server 110 moves target pointer 405 to a node in the second child node set that is the same as the node currently pointed to by source pointer 403. As shown in FIG. 4C, target pointer 405 is moved to node 480. Then, process 300 returns to block 314 to continue iteration, for continuing to acquire and compare child nodes of the nodes (nodes 410 and 480) currently pointed to by source pointer 403 and target pointer 405.

For example, in the example of FIG. 4C, child nodes 420, 421, and 422 of node 410 in first metadata tree 112 are read and stored in the memory, and child nodes 483, 484, and 485 of node 480 in second metadata tree 122 are also read and stored in the memory, for subsequent comparison.

Process 300 starts iteration from block 314. In a certain iteration, if it is determined in block 326 that the node currently pointed to by source pointer 403 does not exist in the second child node set, this means that the node currently pointed to by source pointer 403 is a differential node. In block 328, source server 110 uses the node currently pointed to by source pointer 403 and at least one parent node to construct the differential metadata tree of first metadata tree 112 with respect to second metadata tree 122.

As shown in the example of FIG. 4D, when source pointer 403 points to node 430, if the same node is not found in the corresponding second child node set (including nodes 490 and 491) in second metadata tree 122, it means that node 430 is a new node. Source server 110 uses node 430 and its parent nodes 420, 410, and 401 to construct differential metadata tree 400. In some embodiments, although not shown in the example in the figure, if node 430 in first metadata tree 112 further includes a child node (that is, there is a lower-level node), such child node no longer needs to be read for comparison, but may be added directly to differential metadata tree 400.

In some embodiments, if it is determined in block 314 that the node currently pointed to by source pointer 403 does not have a child node, which means that the node currently pointed to is an end node in the first metadata tree, in block 330, source server 110 ignores the node currently pointed to, and the process proceeds to block 332.

In block 332, source server 110 determines whether the node currently pointed to by source pointer 403 has a sibling node at the same level that has not been traversed, for example, whether another node that has not been traversed exists in the first child node set. If there is such a sibling node, in block 334, source server 110 moves source pointer 403 from the currently pointed node to the sibling node, and the storage of the child node of the node currently pointed to may be released. Then, process 300 continues to return to block 314.

For example, in the example of FIG. 4E, if source pointer 403 points to node 420 in some iterations and source server 110 determines that sibling node 421 in the same level is not traversed, source server 110 moves source pointer 403 from currently pointed node 420 to sibling node 421, and child nodes 430, 431, and 432 of node 420 may be deleted from the memory. In this way, timely deletion may release a space of the memory for storage of other data in a faster manner.

If it is determined in block 332 that no such sibling nods exists, in block 336, source server 110 moves source pointer 403 from the currently pointed node to its parent node, and moves target pointer 405 from the currently pointed node to the parent node. Then, process 300 returns to block 332 to continue to judge whether the node currently pointed to by source pointer 403 has a sibling node.

In the example of FIG. 4E, if source pointer 403 currently points to node 432 and the node does not have a parent node that has not been traversed, source pointer 403 is moved to its parent node, and the target pointer is moved from currently pointed node 483 to its parent node 480. Source server 110 continues to judge that node 420 currently pointed to by source pointer 403 has sibling node 421, and therefore points source pointer 403 to sibling node 421 again. Process 300 continues to iterate to block 314.

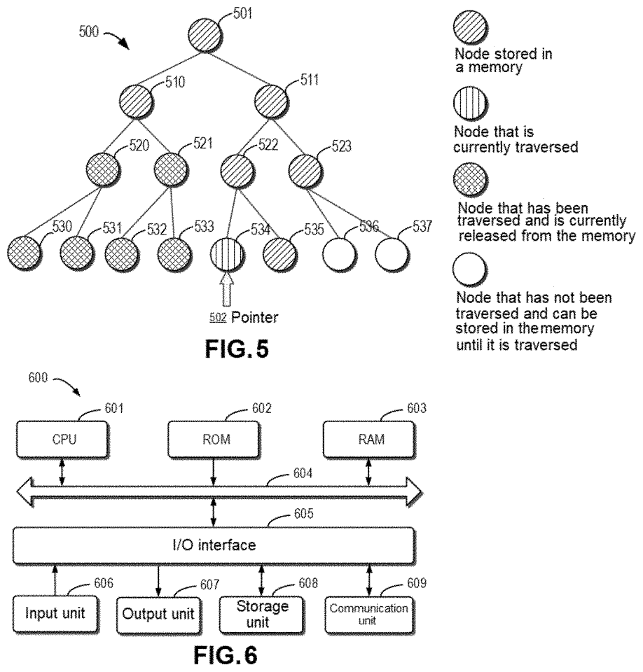

According to various embodiments of the present disclosure, a node currently pointed to by a pointer and its child node are read to compare and generate differential metadata, so that data comparison efficiency can be improved, and storage space utilization can also be improved as there is no need to read the metadata tree completely at one time. FIG. 5 illustrates an example of states of nodes of metadata tree 500 during metadata comparison according to some embodiments of the present disclosure. As shown in FIG. 5, metadata tree 500 includes a plurality of nodes from root node 501 to node 537. In metadata tree 500, when node 534 currently pointed to by associated pointer 502 is traversed, many nodes that have been traversed before have been deleted from the memory, and the nodes that have not been traversed do not need to be read at this time. This can significantly improve the memory utilization.

In addition, as the efficiency of metadata comparison is improved, the time delay of the data replication process that depends on results of the metadata comparison may also be reduced. Based on the determined differential metadata tree, source server 110 may replicate a data part of source data 132 corresponding to the differential metadata tree to storage system 140. After the data is replicated, second metadata tree 122 may be updated to be the same as first metadata tree 112.

FIG. 6 is a schematic block diagram of example device 600 that can be configured to implement an embodiment of the present disclosure. Device 600 may be implemented as or included in source server 110 or target server 120 of FIG. 1.

As shown in the figure, device 600 includes central processing unit (CPU) 601 that can perform various appropriate actions and processing according to computer program instructions stored in read-only memory (ROM) 602 or computer program instructions loaded from storage unit 608 into random access memory (RAM) 603. In RAM 603, various programs and data required for the operation of device 600 can also be stored. CPU 601, ROM 602, and RAM 603 are connected to each other through bus 604. Input/output (I/O) interface 605 is also connected to bus 604.

A plurality of components in device 600 are connected to I/O interface 605, including: input unit 606, such as a keyboard and a mouse; output unit 607, such as various types of displays and speakers; storage unit 608, such as a magnetic disk and an optical disc; and communication unit 609, such as a network card, a modem, and a wireless communication transceiver. Communication unit 609 allows device 600 to exchange information/data with other devices over a computer network such as the Internet and/or various telecommunication networks.

Processing unit 601 performs the various methods and processing described above, such as process 300. For example, in some embodiments, process 300 may be implemented as a computer software program or a computer program product that is tangibly included in a machine-readable medium, such as a non-transitory computer-readable medium, for example, storage unit 608. In some embodiments, part or all of the computer program may be loaded and/or installed onto device 600 via ROM 602 and/or communication unit 609. When the computer program is loaded into RAM 603 and executed by CPU 601, one or more steps of process 300 described above may be implemented. Alternatively, in other embodiments, CPU 601 may be configured to perform process 300 in any other suitable manners (for example, by means of firmware).

Those skilled in the art should understand that the steps of the above method of the present disclosure may be implemented by a general-purpose computing apparatus, and may be centralized on a single computing apparatus or distributed over a network composed of a plurality of computing apparatuses. Optionally, they may be implemented using program code executable by a computing apparatus, so that they may be stored in a storage apparatus and executed by a computing apparatus, or they may be made into integrated circuit modules respectively, or they may be implemented by making a plurality of modules or steps of them into a single integrated circuit module. Thus, the present disclosure is not limited to any particular combination of hardware and software.

It should be understood that although some apparatuses or sub-apparatuses of the device are mentioned in the above detailed description, such division is merely illustrative rather than mandatory. In fact, the features and functions of two or more apparatuses described above may be embodied in one apparatus according to the embodiments of the present disclosure. On the contrary, the features and functions of one apparatus described above can be embodied by further dividing the apparatus into a plurality of apparatuses.

The above description is only optional embodiments of the present disclosure, and is not intended to limit the present disclosure. For those skilled in the art, the present disclosure may take on various modifications and alterations. Any modification, equivalent replacement, improvement, and the like made within the spirit and principle of the present disclosure should be encompassed in the scope of protection of the present disclosure.

1. A method for metadata comparison, comprising:
setting a source pointer to point to a first node in a first metadata tree corresponding to source data;
if it is determined that the first node has at least one child node in the first metadata tree, reading a first child node set of the first node from a first storage system;
if it is determined that a target pointer points to a second node in a second metadata tree corresponding to target data, determining a second child node set of the second node, wherein the target data is a replicated version of the source data, and the second node is the same as the first node; and
determining a differential metadata tree of the first metadata tree with respect to the second metadata tree at least in part by determining a difference between the first child node set and the second child node set.

2. The method of claim 1, further comprising:
if it is determined that the source pointer points to the first node in the first metadata tree, determining whether the second node the same as the first node exists at the same level as that of the first node in the second metadata tree; and
if it is determined that the second node exists in the second metadata tree, causing the target pointer to point to the second node in the second metadata tree.

3. The method of claim 1, wherein the source pointer is created to initially point to a first root node of the first metadata tree, the second metadata tree comprises metadata portions corresponding to a plurality of replicated versions of different source data, and the method further comprises:
creating, based on the source pointer, the target pointer to initially point to a start node of a metadata portion corresponding to the target data in the second metadata tree.

4. The method of claim 1, wherein determining the second child node set of the second node comprises:
if it is determined that the second node has no child node in the second metadata tree, determining the second child node set to be null; and
if it is determined that the second node has at least one child node in the second metadata tree, reading the at least one child node from a second storage system to serve as the second child node set.

5. The method of claim 1, wherein determining the differential metadata tree comprises: for a given child node in the first child node set,
if it is determined that no child node the same as the given child node exists in the second child node set, constructing the differential metadata tree at least based on the given child node and a node at a lower level in the first metadata tree than the level of the given child node, without reading the node at the lower level than the level of the given child node.

6. The method of claim 1, wherein determining the differential metadata tree comprises:
if a third node at the same level as that of the first node in the first metadata tree has not been traversed, moving the source pointer from the first node to the third node;
if it is determined that a fourth node the same as the third node exists in the second metadata tree and the third node has at least one child node in the first metadata tree, moving the target pointer from the second node to the fourth node;
reading a third child node set of the third node from the first storage system;
determining a fourth child node set of the fourth node; and
further determining the differential metadata tree of the first metadata tree with respect to the second metadata tree by determining a difference between the third child node set and the fourth child node set.

7. The method of claim 6, wherein determining the differential metadata tree further comprises:
if it is determined that no node the same as the third node exists in the second metadata tree, constructing the differential metadata tree at least based on the third node and a node at a higher level in the first metadata tree than the level of the third node.

8. The method of claim 6, wherein the first child node set and the second child node set are stored in a memory, and the method further comprises:
if the source pointer is moved from the first node to the third node, releasing the storage of the first child node set and the second child node set from the memory.

9. An electronic device, comprising:
a processor; and
a memory coupled to the processor and storing instructions, which when executed by the processor, cause the processor to perform actions comprising:
setting a source pointer to point to a first node in a first metadata tree corresponding to source data;
if it is determined that the first node has at least one child node in the first metadata tree, reading a first child node set of the first node from a first storage system;
if it is determined that a target pointer points to a second node in a second metadata tree corresponding to target data, determining a second child node set of the second node, wherein the target data is a replicated version of the source data, and the second node is the same as the first node; and
determining a differential metadata tree of the first metadata tree with respect to the second metadata tree at least in part by determining a difference between the first child node set and the second child node set.

10. The device of claim 9, wherein the actions further comprise:
if it is determined that the source pointer points to the first node in the first metadata tree, determining whether the second node the same as the first node exists at the same level as that of the first node in the second metadata tree; and
if it is determined that the second node exists in the second metadata tree, causing the target pointer to point to the second node in the second metadata tree.

11. The device of claim 9, wherein the source pointer is created to initially point to a first root node of the first metadata tree, the second metadata tree comprises metadata portions corresponding to a plurality of replicated versions of different source data, and the method further comprises:
creating, based on the source pointer, the target pointer to initially point to a start node of a metadata portion corresponding to the target data in the second metadata tree.

12. The device of claim 9, wherein determining the second child node set of the second node comprises:
if it is determined that the second node has no child node in the second metadata tree, determining the second child node set to be null; and
if it is determined that the second node has at least one child node in the second metadata tree, reading the at least one child node from a second storage system to serve as the second child node set.

13. The device of claim 9, wherein determining the differential metadata tree comprises: for a given child node in the first child node set,
if it is determined that no child node the same as the given child node exists in the second child node set, constructing the differential metadata tree at least based on the given child node and a node at a lower level in the first metadata tree than the level of the given child node, without reading the node at the lower level than the level of the given child node.

14. The device of claim 9, wherein determining the differential metadata tree comprises:
if a third node at the same level as that of the first node in the first metadata tree has not been traversed, moving the source pointer from the first node to the third node;
if it is determined that a fourth node the same as the third node exists in the second metadata tree and the third node has at least one child node in the first metadata tree, moving the target pointer from the second node to the fourth node;
reading a third child node set of the third node from the first storage system;
determining a fourth child node set of the fourth node; and
further determining the differential metadata tree of the first metadata tree with respect to the second metadata tree by determining a difference between the third child node set and the fourth child node set.

15. The device of claim 14, wherein determining the differential metadata tree further comprises:
if it is determined that no node the same as the third node exists in the second metadata tree, constructing the differential metadata tree at least based on the third node and a node at a higher level in the first metadata tree than the level of the third node.

16. The device of claim 14, wherein the first child node set and the second child node set are stored in a memory, and the actions further comprise:
if the source pointer is moved from the first node to the third node, releasing the storage of the first child node set and the second child node set from the memory.

17. A computer program product, stored on a non-transitory computer-readable medium and comprising computer-executable instructions, which when executed by a processor, cause the processor to perform actions comprising:
setting a source pointer to point to a first node in a first metadata tree corresponding to source data;
if it is determined that the first node has at least one child node in the first metadata tree, reading a first child node set of the first node from a first storage system;
if it is determined that a target pointer points to a second node in a second metadata tree corresponding to target data, determining a second child node set of the second node, wherein the target data is a replicated version of the source data, and the second node is the same as the first node; and
determining a differential metadata tree of the first metadata tree with respect to the second metadata tree at least in part by determining a difference between the first child node set and the second child node set.

18. The computer program product of claim 17, wherein the actions further comprise:
if it is determined that the source pointer points to the first node in the first metadata tree, determining whether the second node the same as the first node exists at the same level as that of the first node in the second metadata tree; and
if it is determined that the second node exists in the second metadata tree, causing the target pointer to point to the second node in the second metadata tree.

19. The computer program product of claim 17, wherein the source pointer is created to initially point to a first root node of the first metadata tree, the second metadata tree comprises metadata portions corresponding to a plurality of replicated versions of different source data, and the method further comprises:
creating, based on the source pointer, the target pointer to initially point to a start node of a metadata portion corresponding to the target data in the second metadata tree.

20. The computer program product of claim 17, wherein determining the second child node set of the second node comprises:
if it is determined that the second node has no child node in the second metadata tree, determining the second child node set to be null; and
if it is determined that the second node has at least one child node in the second metadata tree, reading the at least one child node from a second storage system to serve as the second child node set.

21-24. (canceled)
